(19) United States
(12) Patent Application Publication
(10) Pub. No.: US 2016/0222217 A1
(43) Pub. Date: Aug. 4, 2016

(54) SCRATCH-RESISTANT RADIATION-CURED COATINGS

(71) Applicant: BASF SE, Ludwigshafen (DE)

(72) Inventors: Reinhold SCHWALM, Wachenheim (DE); Lothar ENGELBRECHT, Berlin (DE); Bernhard Ulrich von VACANO, Mannheim (DE)

(73) Assignee: BASF SE, Ludwigshafen (DE)

(21) Appl. No.: 15/021,496

(22) PCT Filed: Sep. 10, 2014
(86) PCT No.: PCT/EP2014/069250

§ 371 Date: Mar. 11, 2016

(30) Foreign Application Priority Data
Sep. 13, 2013 (EP) 13184244.5

(51) Int. Cl. C09D 5/00; C07F 7/08; B05D 3/06; C09D 4/00

(52) U.S. Cl. CPC C09D 5/00; C09D 4/00; C07F 7/0889; C07F 7/0856; B05D 3/067

(57) ABSTRACT

The invention relates to scratch-resistant coatings obtainable by radiative curing, by reaction of (meth)acrylates with mercapto groups, to processes for production thereof and to use thereof.

The invention relates to scratch-resistant coatings obtainable by radiative curing, by reaction of (meth)acrylates with mercapto groups, to processes for production thereof and to use thereof.

U.S. Pat. No. 6,551,710 B1 discloses allowing radiation-curable acrylates to react with compounds comprising thio groups.

Disadvantages of these systems are that the coating compositions are applied from solvents and thus have a high VOC value, and that the mixtures of

UV-curable compound and di- and polythiol component are mixed with one another for immediate reaction and hence cannot be stored.

Reactive mixtures of acrylates and thiol compounds are also known from EP 1275668. Here too, the mixtures are made up for immediate reaction; storage and storability is not envisaged.

A. K. O'Brian, N. B. Cramer, C. N. Bowman describe, in “Oxygen inhibition in Thiol-Acrylate Photopolymerizations”, J. Polym. Sci., Part A: Polymer Chemistry 44: 2007-2014 (2006), the influence of the presence of oxygen (O₂) on the copolymerization of acrylates with thiols in substance. At the same concentration of thiol functionalities, higher-functionality thiols lead to faster polymerization, which makes them even more difficult to stabilize.

In order to reduce any reaction between thiol compounds and systems containing double bonds, according to the teaching of U.S. Pat. No. 5,459,173, it is necessary to stabilize them.

WO 2012/126695 describes storage-stable mixtures of polyacrylates and polythiols. The mixtures described have satisfactory storage stability, but the scratch resistance of the coatings obtained is too low.

In addition, surface-active fluorinated thiols have also been used in radiation-curable coatings which reduce the susceptibility of surfaces to soiling (Y. Ozaki, RadTech Asia 2011).

It was an object of the present invention to provide radiation-curable coating compositions which result in coatings which result in a high scratch resistance even in the presence of oxygen in the course of curing as compared with curing under intergas.

The object was achieved by coating compositions comprising
(A) at least one multifunctional (meth)acrylate having at least two (meth)acrylate groups,
(B) at least one siloxane having at least three silicon atoms, and having at least two thiol groups,
(C) optionally at least one photoinitiator,
(D) optionally at least one compound selected from the group consisting of phosphonic acids, phosphoric acids, phosphorous esters and triarylphosphines,
(E) at least one aromatic compound having at least two hydroxyl groups bonded to the aromatic ring.

### Multifunctional (Meth)Acrylates or Mixtures (A)

Component (A) of the inventive coating compositions is at least one, for example one to six, preferably one to four, more preferably one to three, most preferably one to two and especially one multifunctional (meth)acrylate(s) having at least two (meth)acrylate groups, preferably two to ten, more preferably three to eight, even more preferably three to six and especially three to four.

In the context of this document, (meth)acrylate groups are understood to mean acrylate or methacrylate, preferably acrylate.

The compounds (A) are preferably selected from the group consisting of (A1a) (meth)acrylates of polyols, (A1b) urethane (meth)acrylates, (A1c) polyester (meth)acrylates, (A1d) polyether (meth)acrylates and (A1e) epoxy (meth)acrylates.

Examples of (meth)acrylates of polyols having the corresponding functionality (A1a) are the fully (meth)acrylated or at least tetra(meth)acrylated (meth)acrylic esters of pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol and isomalt, and the up to decaethoxylated and/or -propoxylated (per hydroxyl group), preferably ethoxylated, products thereof.

Preference is given to the fully (meth)acrylated or at least tetra(meth)acrylated (meth)acrylic esters of pentaerythritol, ditrimethylolpropane or dipentaerythritol, and the up to hexaethoxylated and/or -propoxylated, preferably up to tetraethoxylated and/or -propoxylated and more preferably up to triethoxylated and/or -propoxylated (per hydroxyl group), preferably ethoxylated, products thereof.

More preferably, the compounds (A1a) are pentaerythrityl tetraacrylate, ditrimethylolpropane tetraacrylate, dipentaerythrityl pentaacrylate or dipentaerythrityl hexaacrylate.

The urethane (meth)acrylates (A1b) are urethane (meth)acrylates having the required functionality and a number-average molar mass Mₙ of less than 4000 g/mol, preferably of less than 3000 g/mol, more preferably of less than 2000 g/mol (determined by gel permeation chromatography with tetrahydrofuran and polystyrene as standard).

These generally comprise, as formation components,
(Aa) at least one organic aliphatic, aromatic or cycloaliphatic di- or polyisocyanate,
(Ab) at least one compound (Ab) having at least one isocyanate-reactive group and at least one free-radically polymerizable unsaturated group,
(Ac) optionally at least one compound having at least two isocyanate-reactive groups, and
(Ad) optionally at least one compound having exactly one isocyanate-reactive group.

Component (Aa) may comprise monomers or oligomers of aliphatic or cycloaliphatic diisocyanates.

The NCO functionality of such a compound is generally at least 1.8 and may be up to 8, preferably 1.8 to 5, and more preferably 2 to 4.

The amount of isocyanate groups, calculated as NCO=42 g/mol, is generally 5% to 25% by weight.

The diisocyanates are preferably isocyanates having 4 to 20 carbon atoms. Examples of typical diisocyanates are aliphatic diisocyanates such as tetramethylene diisocyanate, pentamethylene 1,5-diisocyanate, hexamethylene diisocyanate (1,6-diisocyanatohexane), octamethylene diisocyanate, decamethylene diisocyanate, dodecamethylene diisocyanate, tetradecamethylene diisocyanate, derivatives of lysine diisocyanate, trimethylhexane diisocyanate or tetramethylhexane diisocyanate, cycloaliphatic diisocyanates such as 1,4-, 1,3- or 1,2-diisocyanatocyclohexane, 4,4′- or 2,4′-di(isocyanatocyclohexyl)methane, 1-isocyanato-3,3,5-trimethyl-5-(isocyanatomethyl)cyclohexane (isophorone diisocyanate), 1,3- or 1,4-bis(isocyanatomethyl)cyclohexane or 2,4- or 2,6-diisocyanato-1-methylcyclohexane, and also 3(or 4),8(or 9)-bis(isocyanatomethyl)tricyclo[5.2.1.0^{2,6}]decane isomer mixtures.

Mixtures of said diisocyanates may also be present.

Particular preference is given to hexamethylene diisocyanate, 1,3-bis-(isocyanatomethyl)cyclohexane, isophorone diisocyanate, and 4,4′- or 2,4′-di-(isocyanatocyclohexyl)methane, very particular preference to isophorone diisocyanate and hexamethylene diisocyanate, and especial preference to hexamethylene diisocyanate.

Isophorone diisocyanate is usually in the form of a mixture, specifically a mixture of the cis and trans isomers, generally in a proportion of about 60:40 to 80:20 (w/w), preferably in a proportion of about 70:30 to 75:25, and more preferably in a proportion of approximately 75:25. Dicyclohexylmethane 4,4′-diisocyanate may likewise be in the form of a mixture of the different cis and trans isomers.

Cycloaliphatic isocyanates are those which comprise at least one cycloaliphatic ring system.

Aliphatic isocyanates are those which comprise exclusively linear or branched chains, in other words acyclic compounds.

Also suitable are higher isocyanates having an average of more than 2 isocyanate groups. Suitable examples for this purpose are triisocyanates such as triisocyanatononane or 2,4,6-triisocyanatotoluene.

Useful polyisocyanates include polyisocyanates having isocyanurate groups, uretdione diisocyanates, polyisocyanates having biuret groups, polyisocyanates having urethane groups or allophanate groups, polyisocyanates comprising oxadiazinetrione groups, uretonimine-modified polyisocyanates, carbodiimide, hyperbranched polyisocyanates, polyurethane-polyisocyanate prepolymers or polyurea-polyisocyanate prepolymers of linear or branched C₄-C₂₀-alkylene diisocyanates, cycloaliphatic diisocyanates having a total of 6 to 20 carbon atoms, or mixtures thereof.

The di- and polyisocyanates which can be used preferably have an isocyanate group (calculated as NCO, molecular weight=42) content of 10 to 60% by weight, based on the di- and polyisocyanate (mixture), preferably 15 to 60% by weight and more preferably 20 to 55% by weight.

Preference is given to aliphatic and/or cycloaliphatic di- and polyisocyanates, referred to collectively as (cyclo)aliphatic in the context of this specification, examples being the aliphatic and/or cycloaliphatic diisocyanates stated above, or mixtures thereof.

For the present invention it is possible to use not only those di- and polyisocyanates obtained by phosgenating the corresponding amines but also those prepared without the use of phosgene, i.e., by phosgene-free processes. According to EP-A-0 126 299 (U.S. Pat. No. 4,596,678), EP-A-126 300 (U.S. Pat. No. 4,596,679), and

EP-A-355 443 (U.S. Pat. No. 5,087,739), for example, (cyclo)aliphatic diisocyanates, such as hexamethylene 1,6-diisocyanate (HDI), isomeric aliphatic diisocyanates having 6 carbon atoms in the alkylene radical, 4,4′- or 2,4′-di(isocyanatocyclohexyl)methane, and 1-isocyanato-3-isocyanatomethyl-3,5,5-trimethylcyclohexane (isophorone diisocyanate or IPDI), for example, can be prepared by reacting the (cyclo)aliphatic diamines with, for example, urea and alcohols to give (cyclo)aliphatic biscarbamic esters and subjecting said esters to thermal cleavage into the corresponding diisocyanates and alcohols. The synthesis is usually effected continuously in a circulation process and optionally in the presence of N-unsubstituted carbamic esters, dialkyl carbonates, and other by-products recycled from the reaction process. Di- or polyisocyanates obtained in this way generally contain a very low or even unmeasurable fraction of chlorinated compounds, leading to favorable color numbers in the products.

In one embodiment of the present invention, the di- and polyisocyanates (Aa) have a total hydrolyzable chlorine content of less than 200 ppm, preferably of less than 120 ppm, more preferably less than 80 ppm, even more preferably less than 50 ppm, in particular less than 15 ppm, and especially less than 10 ppm. This can be measured, for example, by ASTM method D4663-98. It is of course also possible to use di- and polyisocyanates (Aa) having a higher chlorine content.

The di- and polyisocyanates (Aa) may also be at least partly in blocked form.

Preference extends to
1) Polyisocyanates having isocyanurate groups and derived from aliphatic and/or cycloaliphatic diisocyanates. Particular preference here is given to the corresponding aliphatic and/or cycloaliphatic isocyanatoisocyanurates and in particular to those based on hexamethylene diisocyanate and isophorone diisocyanate. These present isocyanurates are, in particular, trisisocyanatoalkyl and/or trisisocyanatocycloalkyl isocyanurates, which are cyclic trimers of the diisocyanates, or are mixtures with their higher homologs containing more than one isocyanurate ring. The isocyanatoisocyanurates generally have an NCO content of 10 to 30% by weight, in particular 15 to 25% by weight, and an average NCO functionality of 2.6 to 8.
2) Uretdione diisocyanates with aliphatically and/or cycloaliphatically attached isocyanate groups, preferably aliphatically and/or cycloaliphatically attached, and in particular those derived from hexamethylene diisocyanate or isophorone diisocyanate. Uretdione diisocyanates are cyclic dimerization products of diisocyanates.
   The uretdione diisocyanates can be used as a sole component or in a mixture with other polyisocyanates, particularly those specified under 1).
3) Polyisocyanates having biuret groups and having cycloaliphatically or aliphatically attached, preferably cycloaliphatically or aliphatically attached, isocyanate groups, especially tris(6-isocyanatohexyl)biuret or mixtures thereof with higher homologs thereof. These polyisocyanates having biuret groups generally have an NCO content of 18% to 22% by weight and an average NCO functionality of 2.8 to 4.5.
4) Polyisocyanates having urethane and/or allophanate groups and having aliphatically or cycloaliphatically attached, preferably aliphatically or cycloaliphatically attached, isocyanate groups, such as may be obtained, for example, by reacting excess amounts of hexamethylene diisocyanate or of isophorone diisocyanate with mono- or polyhydric alcohols, for example methanol, ethanol, iso-propanol, n-propanol, n-butanol, iso-butanol, sec-butanol, tert-butanol, n-hexanol, n-heptanol, n-octanol, n-decanol, n-dodecanol (lauryl alcohol), 2-ethylhexanol, n-pentanol, stearyl alcohol, cetyl alcohol, lauryl alcohol, ethylene glycol monomethyl ether, ethylene glycol monoethyl ether, propane-1,3-diol monomethyl ether, cyclopentanol, cyclohexanol, cyclooctanol, cyclododecanol, trimethylolpropane, neopentyl glycol, pentaerythritol, butane-1,4-diol, hexane-1,6-diol, propane-1,3-diol, 2-ethylpropane-1,3-diol, 2-methylpropane-1,3-diol, ethylene glycol, diethylene glycol, triethylene glycol, tetraethylene glycol, pentaethylene glycol, glycerol, 1,2-dihydroxypropane, 2,2-dimethylethane-1,2-diol, butane-1,2-diol, butane-1,4-diol, 3-methylpentane-1,5-diol, 2-ethylhexane-1,3-diol, 2,4-diethyloctane-1,3-diol, hydroxypivalic acid neopentyl glycol ester, ditrimethylolpropane, dipentaerythritol, 2,2-bis(4-hydroxycyclohexyl)propane, cyclohexane-1,1-, -1,2-, -1,3- and -1,4-dimethanol, cyclohexane-1,2-, -1,3- or -1,4-diol, or mixtures thereof. These polyisocyanates having urethane and/or allophanate groups generally have an NCO content of 12 to 20% by weight and an average NCO functionality of 2.5 to 4.5.
5) Polyisocyanates comprising oxadiazinetrione groups, derived preferably from hexamethylene diisocyanate or isophorone diisocyanate. Polyisocyanates of this kind comprising oxadiazinetrione groups are obtainable from diisocyanate and carbon dioxide.
6) Polyisocyanates comprising iminooxadiazinedione groups, derived preferably from hexamethylene diisocyanate or isophorone diisocyanate. Polyisocyanates of this kind comprising iminooxadiazinedione groups are preparable from diisocyanates by means of specific catalysts.
7) Uretonimine-modified polyisocyanates.
8) Carbodiimide-modified polyisocyanates.
9) Hyperbranched polyisocyanates, of the kind known for example from DE-A1 10013186 or DE-A1 10013187.
10) Polyurethane-polyisocyanate prepolymers, from di- and/or polyisocyanates with alcohols.
11) Polyurea-polyisocyanate prepolymers.

Polyisocyanates 1) to 11) may be used in a mixture, optionally also in a mixture with diisocyanates.

In a preferred embodiment of the present invention, component (Aa) is a polyisocyanate and is selected from the group consisting of isocyanurates, biurets, urethanes and allophanates, preferably from the group consisting of isocyanurates, urethanes and allophanates, more preferably from the group consisting of isocyanurates and allophanates.

The fraction of other groups which form from isocyanate groups, especially of isocyanurate, biuret, uretdione, iminooxadiazinetrione and/or carbodiimide groups, is of minor significance in accordance with the invention.

In a further preferred embodiment, component (Aa) comprises polyisocyanates having isocyanurate groups. The isocyanatoisocyanurates generally have an NCO content of 10 to 30% by weight, in particular 15 to 25% by weight, and an average NCO functionality of 2.6 to 8.

In a preferred embodiment of the invention, the urethane (meth)acrylates have virtually no free isocyanate groups any longer; in other words, the amount of free isocyanate groups is less than 0.5% by weight, preferably less than 0.3%, more preferably less than 0.2%, very preferably less than 0.1%, in particular less than 0.05%, and especially 0% by weight.

As a result of their preparation, polyisocyanates (Aa) may still have a small fraction of their parent monomeric diisocyanate, this fraction being up to 5% by weight for example, more preferably up to 3% by weight, very preferably up to 2%, in particular up to 1%, especially up to 0.5%, and even up to 0.25% by weight.

Compounds suitable as component (Ab) include, in accordance with the invention, compounds which bear at least one isocyanate-reactive group and at least one free-radically polymerizable group.

In a preferred embodiment of the invention, the compound (Ab) is made up of compounds having exactly one isocyanate-reactive group. The number of free-radically polymerizable unsaturated groups is at least one, preferably one to five, more preferably one to four, and very preferably one to three free-radically polymerizable unsaturated groups.

The components (Ab) preferably have a molar mass below 10 000 g/mol, more preferably below 5000 g/mol, very preferably below 4000 g/mol, and in particular below 3000 g/mol. Specific compounds (Ab) have a molar mass below 1000 or even below 600 g/mol. Isocyanate-reactive groups may, for example, be —OH, —SH, —NH₂ and —NHR⁵ where R⁵ is hydrogen or an alkyl group comprising 1 to 4 carbon atoms, for example methyl, ethyl, n-propyl, iso-propyl, n-butyl, iso-butyl, sec-butyl or tert-butyl.

Isocyanate-reactive groups may preferably be —OH, —NH₂ or —NHR⁵, more preferably —OH or —NH₂ and most preferably —OH.

Examples of possible components (Ab) include monoesters of α,β-unsaturated carboxylic acids such as acrylic acid or methacrylic acid, preferably acrylic acid, with diols or polyols having preferably 2 to 20 carbon atoms and at least two hydroxyl groups, such as ethylene glycol, diethylene glycol, triethylene glycol, 1,2-propylene glycol, 1,3-propylene glycol, 1,1-dimethylethane-1,2-diol, dipropylene glycol, triethylene glycol, tetraethylene glycol, pentaethylene glycol, tripropylene glycol, butane-1,2-, -1,3- or -1,4-diol, pentane-1,5-diol, neopentyl glycol, hexane-1,6-diol, 2-methylpentane-1,5-diol, 2-ethylbutane-1,4-diol, 1,4-dimethylolcyclohexane, 2,2-bis(4-hydroxycyclohexyl)propane, glycerol, trimethylolethane, trimethylolpropane, trimethylolbutane, pentaerythritol, ditrimethylolpropane, erythritol, sorbitol, polyTHF having a molar weight between 162 and 2000, polypropane-1,3-diol having a molar weight between 134 and 400 or polyethylene glycol having a molar weight between 238 and 458.

In addition, unsaturated polyetherols or polyesterols or polyacrylate polyols having an average OH functionality of 2 to 10 are also suitable, albeit less preferably.

Preference is given to using 2-hydroxyethyl (meth)acrylate, 2- or 3-hydroxypropyl (meth)acrylate, butane-1,4-diol mono(meth)acrylate, neopentyl glycol mono(meth)acrylate, pentane-1,5-diol mono(meth)acrylate, hexane-1,6-diol mono(meth)acrylate, glyceryl mono(meth)acrylate and di(meth)acrylate, trimethylolpropane mono(meth)acrylate and di(meth)acrylate, pentaerythrityl mono(meth)acrylate, di(meth)acrylate, and tri(meth)acrylate, and also 4-hydroxybutyl vinyl ether, 2-aminoethyl (meth)acrylate, 2-aminopropyl (meth)acrylate, 3-aminopropyl (meth)acrylate, 4-aminobutyl (meth)acrylate, 6-aminohexyl (meth)acrylate, 2-thioethyl (meth)acrylate, 2-aminoethyl(meth)acrylamide, 2-aminopropyl(meth)acrylamide, 3-aminopropyl(meth)acrylamide, 2-hydroxyethyl(meth)acrylamide, 2-hydroxypropyl(meth)acrylamide or 3-hydroxypropyl(meth)acrylamide. Particular preference is given to 2-hydroxyethyl acrylate, 2-hydroxyethyl methacrylate, 2- or 3-hydroxypropyl acrylate, butane-1,4-diol monoacrylate, 3-(acryloyloxy)-2-hydroxypropyl (meth)acrylate, and the monoacrylates of polyethylene glycol with a molar mass of 106 to 238.

Examples of useful components (Ac) include compounds having at least two, preferably exactly two, isocyanate-reactive groups, for example —OH, —SH, —NH₂ or —NHR⁵ in which R⁵ is independently hydrogen, methyl, ethyl, iso-propyl, n-propyl, n-butyl, iso-butyl, sec-butyl or tert-butyl

Isocyanate-reactive groups may preferably be —OH, —NH₂ or —NHR⁵, more preferably —OH or —NH₂ and most preferably —OH.

These are preferably diols containing 2 to 20 carbon atoms, examples being ethylene glycol, propane-1,2-diol, propane-1,3-diol, 1,1-dimethylethane-1,2-diol, 2-butyl-2-ethylpropane-1,3-diol, 2-ethylpropane-1,3-diol, 2-methylpropane-1,3-diol, neopentyl glycol, neopentyl glycol hydroxypivalate, butane-1,2-, -1,3- or -1,4-diol, hexane-1,6-diol, decane-1,10-diol, bis(4-hydroxycyclohexane)isopropylidene, tetramethylcyclobutanediol, cyclohexane-1,2-, -1,3- or -1,4-diol, cyclooctanediol, norbornanediol, pinanediol, decalindiol, 2-ethylhexane-1,3-diol, 2,4-diethyloctane-1,3-diol, hydroquinone, bisphenol A, bisphenol F, bisphenol B, bisphenol S, 2,2-bis(4-hydroxycyclohexyl)propane, cyclohexane-1,1-, -1,2-, -1,3-, and -1,4-dimethanol, cyclohexane-1,2-, -1,3- or -1,4-diol, polyTHF having a molar mass between 162 and 2000, polypropane-1,2-diol or polypropane-1,3-diol having a molar mass between 134 and 1178 or polyethylene glycol having a molar mass between 106 and 2000, and aliphatic diamines, such as methylene- and isopropylidenebis(cyclohexylamine), piperazine, 1,2-, 1,3- or 1,4-diaminocyclohexane, 1,2-, 1,3- or 1,4-cyclohexane bis(methylamine), etc., dithiols or polyfunctional alcohols, secondary or primary amino alcohols, such as ethanolamine, monopropanolamine, etc., or thio alcohols, such as thioethylene glycol.

Polyester polyols are known, for example, from Ullmanns Encyklopädie der technischen Chemie, 4th edition, volume 19, p. 62 to 65. Preference is given to using polyester polyols which are obtained by reacting dihydric alcohols with dibasic carboxylic acids. In the place of the free carboxylic acids, it is also possible to produce the polyester polyols using the corresponding polycarboxylic anhydrides or the corresponding polycarboxylic acid esters of lower alcohols or their mixtures. The polycarboxylic acids may be aliphatic, cycloaliphatic, araliphatic, aromatic or heterocyclic and may be optionally substituted, for example by halogen atoms, and/or unsaturated. Examples of these include:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄-alkyl esters for example, preferably methyl, ethyl or n-butyl esters, of said acids are used. Preference is given to dicarboxylic acids of the general formula HOOC—(CH₂)_{y}—COOH where y is a number from 1 to 20, preferably an even number from 2 to 20; more preferably succinic acid, adipic acid, sebacic acid, and dodecanedicarboxylic acid.

Suitable polyhydric alcohols for preparing the polyesterols include

propane-1,2-diol, ethylene glycol, 2,2-dimethylethane-1,2-diol, propane-1,3-diol, butane-1,2-diol, butane-1,3-diol, butane-1,4-diol, 3-methylpentane-1,5-diol, 2-ethylhexane-1,3-diol, 2,4-diethyloctane-1,3-diol, hexane-1,6-diol, polyTHF having a molar mass between 162 and 2000, polypropane-1,3-diol having a molar mass between 134 and 1178, polypropane-1,2-diol having a molar mass between 134 and 898, polyethylene glycol having a molar mass between 106 and 458, neopentyl glycol, neopentyl glycol hydroxypivalate, 2-ethylpropane-1,3-diol, 2-methylpropane-1,3-diol, 2,2-bis(4-hydroxycyclohexyl)propane, cyclohexane-1,1-, -1,2-, -1,3- and -1,4-dimethanol, cyclohexane-1,2-, -1,3- or -1,4-diol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which may optionally have been alkoxylated as described above.

Preferred alcohols are those of the general formula HO—(CH₂)ₓ—OH where x is a number from 1 to 20, preferably an even number from 2 to 20. Preference is given to ethylene glycol, butane-1,4-diol, hexane-1,6-diol, octane-1,8-diol, and dodecane-1,12-diol. Preference is further given to neopentyl glycol.

In addition, polycarbonate diols are also useful, as can be obtained for example by reacting phosgene with an excess of the low molecular weight alcohols mentioned as formation components for the polyester polyols.

Other polyester diols which are suitable are based on lactones, taking the form of lactone homopolymers or mixed polymers, preferably of adducts, having terminal hydroxyl groups, of lactones onto suitable difunctional starter molecules. Suitable lactones are preferably those which are derived from compounds of the general formula HO—(CH₂)_{z}—COOH where z is a number from 1 to 20 and one hydrogen atom of a methylene unit may also be replaced by a C₁- to C₄-alkyl radical. Examples are ε-caprolactone, β-propiolactone, gamma-butyrolactone and/or methyl-ε-caprolactone, 4-hydroxybenzoic acid, 6-hydroxy-2-naphthoic acid or pivalolactone, and mixtures thereof. Examples of suitable starter components are the low molecular weight divalent alcohols which have been mentioned above as formation component for the polyester polyols. The corresponding polymers of ε-caprolactone are particularly preferred. Other possible starters used for preparation of the lactone polymers are lower polyester diols or polyether diols. Instead of the lactone polymers, it is also possible to use the corresponding chemically equivalent polycondensates of the hydroxycarboxylic acids which correspond to the lactones.

Particularly suitable here are the cycloaliphatic diols, for example bis(4-hydroxycyclohexane)isopropylidene, tetramethylcyclobutanediol, cyclohexane-1,2-, -1,3- or -1,4-diol, cyclohexane-1,1-, -1,2-, -1,3- and -1,4-dimethanol, cyclooctanediol or norbornanediol.

Compounds (Ac) having more than two isocyanate-reactive groups may preferably be polyols having preferably 2 to 20 carbon atoms, examples being trimethylolbutane, trimethylolpropane, trimethylolethane, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol, isomalt; particular preference is given to trimethylolpropane, pentaerythritol and glycerol, and very particular preference to trimethylolpropane.

Optional components (Ad) are those having optionally at least one compound having exactly one isocyanate-reactive group.

The compounds in question are preferably monools, more preferably alkanols, and very preferably alkanols having 1 to 20, preferably 1 to 12, more preferably 1 to 6, very preferably 1 to 4, and in particular 1 to 2 carbon atoms.

Examples thereof are methanol, ethanol, iso-propanol, n-propanol, n-butanol, iso-butanol, sec-butanol, tert-butanol, n-hexanol, n-heptanol, n-octanol, n-decanol, n-dodecanol (lauryl alcohol), 2-ethylhexanol, cyclopentanol, cyclohexanol, cyclooctanol, cyclododecanol, ethylene glycol monomethyl ether, ethylene glycol monoethyl ether, diethylene glycol, 1,3-propanediol monomethyl ether, preferably methanol, ethanol, iso-propanol, n-propanol, n-butanol, tert-butanol, n-hexanol, 2-ethylhexanol, cyclopentanol, cyclohexanol, and cyclododecanol, more preferably methanol, ethanol, iso-propanol, n-propanol, n-butanol and tert-butanol, even more preferably methanol and ethanol, and especially methanol.

In a preferred embodiment, the monools may be the stated cycloaliphatic alcohols, preferably cyclopentanol or cyclohexanol, more preferably cyclohexanol.

In a further preferred embodiment, the monools may be the stated aliphatic alcohols having 6 to 20 carbon atoms, more preferably those having 8 to 20 carbon atoms, most preferably those having 10 to 20 carbon atoms.

In a particularly preferred embodiment, the monools are the stated aliphatic alcohols, more preferably those having 1 to 4 carbon atoms, especially methanol.

The urethane (meth)acrylates are obtained by reaction of components (Aa) and (Ab), and optionally (Ac) and/or (Ad), with one another.

In this reaction, the molar composition of (Aa):(Ab):(Ac):(Ad):(Ag) per 1 mol of reactive isocyanate groups in (Aa) is generally as follows:
(Ab) 1-50, preferably 5-40, more preferably 10-37.5 and especially
   15-33 mol % of isocyanate-reactive groups,
(Ac) 0-50, preferably 0-30, more preferably 0-25 and especially
   0-20 mol % of isocyanate-reactive groups,
(Ad) 0-5, preferably 0-4, more preferably 0-3 and especially
   0-2 mol % of isocyanate-reactive groups,
      with the proviso that the sum total of the isocyanate-reactive groups corresponds to the number of isocyanate groups in (Aa).

The formation of the adduct of isocyanato-functional compound and the compound comprising groups reactive toward isocyanate groups is generally effected by mixing of the components in any order, optionally at elevated temperature.

This preferably involves adding the compound comprising groups reactive toward isocyanate groups to the isocyanato-functional compound, preferably in two or more steps. Particular preference is given to initially charging the isocyanato-functional compound and adding the compounds comprising isocyanate-reactive groups. More particularly, the isocyanato-functional compound (Aa) is initially charged and then (Ab) is added. Thereafter it is possible to add optionally desired further components.

In general, the reaction is carried out at temperatures between 5 and 100° C., preferably between 20 to 90° C., more preferably between 40 and 80° C., and in particular between 60 and 80° C.

Preference is given to working under anhydrous conditions during the preparation of the polyurethane.

Anhydrous here means that the water content of the reaction system is not more than 5% by weight, preferably not more than 3% by weight, and more preferably not more than 1% by weight; with very particular preference it is not more than 0.75% and in particular not more than 0.5% by weight.

The reaction is carried out preferably in the presence of at least one oxygenous gas, examples being air or air/nitrogen mixtures, or mixtures of oxygen or an oxygenous gas with a gas which is inert under the reaction conditions, having an oxygen content of below 15%, preferably below 12%, more preferably below 10%, very preferably below 8%, and in particular below 6% by volume.

The reaction can also be carried out in the presence of an inert solvent, examples being acetone, iso-butyl methyl ketone, toluene, xylene, butyl acetate, methoxypropyl acetate or ethoxyethyl acetate. With preference, however, the reaction is carried out in the absence of a solvent.

In one preferred embodiment the reaction of (Aa) with (Ab) can be carried out under allophanatization conditions.

Typical catalysts for such a reaction are organozinc compounds, such as zinc acetylacetonate or zinc 2-ethylcaproate, or a tetraalkylammonium compound, such as N,N,N-trimethyl-N-2-hydroxypropylammonium hydroxide or such as N,N,N-trimethyl-N-2-hydroxypropylammonium 2-ethylhexanoate, or organotin compounds, such as dibutyltin dilaurate.

As catalysts these preferably bismuth compounds, zinc compounds and/or titanium compounds, preferably of a bismuth compound and/or titanium compound and more preferably of a bismuth compound.

Useful zinc and bismuth compounds include those in which the following anions are used: F⁻, Cl⁻, ClO⁻, ClO₃⁻, ClO₄⁻, Br⁻, I⁻, IO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₁O₂)⁻, (CₙH₂ₙ₋₃O₂)⁻ and (Cₙ₊₁H₂ₙ₋₂O₄)²⁻, where n represents the numbers 1 to 20. Preference is given to the carboxylates in which the anion obeys the formulae (CₙH₂ₙ₋₁O₂)⁻ and (Cₙ₊₁H₂ₙ₋₂O₄)²⁻ where n is 1 to 20. Particularly preferred salts have, as anions, monocarboxylates of the general formula (CₙH₂ₙ₋₁O₂)⁻ where n represents the numbers 1 to 20.

Particular mention should be made here of formate, acetate, propionate, hexanoate, neodecanoate and 2-ethylhexanoate.

Among the zinc catalysts, preference is given to the zinc carboxylates, particular preference to those of carboxylates having at least six carbon atoms, most preferably at least eight carbon atoms, especially zinc(II) diacetate or zinc(II) dioctoate or zinc(II) neodecanoate. Commercially available catalysts are, for example, Borchi® Kat 22 from OMG Borchers GmbH, Langenfeld, Germany.

Among the bismuth catalysts, preference is given to the bismuth carboxylates, particular preference to those of carboxylates having at least six carbon atoms, especially bismuth octoates, ethylhexanoates, neodecanoates or pivalates; for example K-KAT 348, XC-B221; XC-C227, XC 8203 and XK-601 from King Industries, TIB KAT 716, 716LA, 716XLA, 718, 720, 789 from TIB Chemicals and those from Shepherd Lausanne, and also, for example, Borchi® Kat 24; 315; 320 from OMG Borchers GmbH, Langenfeld, Germany.

Mixtures of different metals may be involved, as, for example, in Borchi® Kat 0245 from OMG Borchers GmbH, Langenfeld, Germany.

Among the titanium compounds, preference is given to the titanium tetraalkoxides Ti(OR)₄, particular preference to those of alcohols ROH having 1 to 8 carbon atoms, for example methanol, ethanol, iso-propanol, n-propanol, n-butanol, iso-butanol, sec-butanol, tert-butanol, n-hexanol, n-heptanol, n-octanol, preferably methanol, ethanol, iso-propanol, n-propanol, n-butanol, tert-butanol, more preferably isopropanol and n-butanol.

In another preferred embodiment compounds are used of the kind described in WO 00/39183, p. 4, I. 3 to p. 10, I. 19, the disclosure content of which is hereby made part of the present specification. Particular preference among these compounds is given to those having as formation components at least one (cyclo)aliphatic isocyanate which contains allophanate groups, and at least one hydroxyalkyl (meth)acrylate, very particular preference being given to products 1 to 9 in table 1 on p. 24 of WO 00/39183.

Polyester (meth)acrylates (A1c) are, for example, (meth)acrylates of polyester polyols having the required functionality.

Polyester polyols are known, for example, from Ullmanns Encyklopädie der technischen Chemie, 4th edition, volume 19, p. 62 to 65. Preference is given to using polyester polyols which are obtained by reacting dihydric alcohols with dibasic carboxylic acids. In the place of the free carboxylic acids, it is also possible to produce the polyester polyols using the corresponding polycarboxylic anhydrides or the corresponding polycarboxylic acid esters of lower alcohols or their mixtures. The polycarboxylic acids may be aliphatic, cycloaliphatic, araliphatic, aromatic or heterocyclic and may be optionally substituted, for example by halogen atoms, and/or unsaturated. Examples of these include:

oxalic acid, maleic acid, fumaric acid, succinic acid, glutaric acid, adipic acid, sebacic acid, dodecanedioic acid, o-phthalic acid, isophthalic acid, terephthalic acid, trimellitic acid, azelaic acid, 1,4-cyclohexanedicarboxylic acid or tetrahydrophthalic acid, suberic acid, azelaic acid, phthalic anhydride, tetrahydrophthalic anhydride, hexahydrophthalic anhydride, tetrachlorophthalic anhydride, endomethylenetetrahydrophthalic anhydride, glutaric anhydride, maleic anhydride, dimeric fatty acids, their isomers and hydrogenation products, and also esterifiable derivatives, such as anhydrides or dialkyl esters, C₁-C₄-alkyl esters for example, preferably methyl, ethyl or n-butyl esters, of said acids are used. Preference is given to dicarboxylic acids of the general formula HOOC—(CH₂)_{y}—COOH where y is a number from 1 to 20, preferably an even number from 2 to 20; more preferably succinic acid, adipic acid, sebacic acid, and dodecanedicarboxylic acid.

Suitable polyhydric alcohols for preparing the polyesterols include

propane-1,2-diol, ethylene glycol, 2,2-dimethylethane-1,2-diol, propane-1,3-diol, butane-1,2-diol, butane-1,3-diol, butane-1,4-diol, 3-methylpentane-1,5-diol, 2-ethylhexane-1,3-diol, 2,4-diethyloctane-1,3-diol, hexane-1,6-diol, polyTHF having a molar mass between 162 and 2000, polypropane-1,3-diol having a molar mass between 134 and 1178, polypropane-1,2-diol having a molar mass between 134 and 898, polyethylene glycol having a molar mass between 106 and 458, neopentyl glycol, neopentyl glycol hydroxypivalate, 2-ethylpropane-1,3-diol, 2-methylpropane-1,3-diol, 2,2-bis(4-hydroxycyclohexyl)propane, cyclohexane-1,1-, -1,2-, -1,3- and -1,4-dimethanol, cyclohexane-1,2-, -1,3- or -1,4-diol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt, which may optionally have been alkoxylated as described above.

Preferred alcohols are those of the general formula HO—(CH₂)ₓ—OH where x is a number from 1 to 20, preferably an even number from 2 to 20. Preference is given to ethylene glycol, butane-1,4-diol, hexane-1,6-diol, octane-1,8-diol, and dodecane-1,12-diol. Preference is further given to neopentyl glycol.

Polyether (meth)acrylates (A1d) are (meth)acrylic esters, preferably acrylic esters, of up to decaethoxylated and/or -propoxylated (per hydroxyl group), preferably ethoxylated, polyalcohols.

The polyalcohols in question are at least difunctional, preferably di- to hexafunctional, more preferably di- to tetrafunctional and most preferably di- or trifunctional.

Examples of polyols are propane-1,2-diol, ethylene glycol, 2,2-dimethylethane-1,2-diol, propane-1,3-diol, butane-1,2-diol, butane-1,3-diol, butane-1,4-diol, 3-methylpentane-1,5-diol, 2-ethylhexane-1,3-diol, 2,4-diethyloctane-1,3-diol, hexane-1,6-diol, polyTHF having a molar mass between 162 and 2000, polypropane-1,3-diol having a molar mass between 134 and 1178, polypropane-1,2-diol having a molar mass between 134 and 898, polyethylene glycol having a molar mass between 106 and 458, neopentyl glycol, neopentyl glycol hydroxypivalate, 2-ethylpropane-1,3-diol, 2-methylpropane-1,3-diol, 2,2-bis(4-hydroxycyclohexyl)propane, cyclohexane-1,1-, -1,2-, -1,3- and -1,4-dimethanol, cyclohexane-1,2-, -1,3- or -1,4-diol, trimethylolbutane, trimethylolpropane, trimethylolethane, neopentyl glycol, pentaerythritol, glycerol, ditrimethylolpropane, dipentaerythritol, sorbitol, mannitol, diglycerol, threitol, erythritol, adonitol (ribitol), arabitol (lyxitol), xylitol, dulcitol (galactitol), maltitol or isomalt.

Epoxy (meth)acrylates (A1e) are obtainable by reacting epoxides with (meth)acrylic acid. Examples of suitable epoxides include epoxidized olefins, aromatic glycidyl ethers or aliphatic glycidyl ethers, preferably those of aromatic or aliphatic glycidyl ethers.

Examples of possible epoxidized olefins include ethylene oxide, propylene oxide, isobutylene oxide, 1-butene oxide, 2-butene oxide, vinyloxirane, styrene oxide or epichlorohydrin, preference being given to ethylene oxide, propylene oxide, isobutylene oxide, vinyloxirane, styrene oxide or epichlorohydrin, particular preference to ethylene oxide, propylene oxide or epichlorohydrin, and very particular preference to ethylene oxide and epichlorohydrin.

Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]).

Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

Preferred aliphatic glycidyl ethers are the formal reaction products of epichlorohydrin with polyethylene glycol of molar mass 62 to 1000, polypropylene glycol of molar mass 76 to 1000, polyTHF having a molar mass of 162 to 2000, polycaprolactonediols of molar mass up to 1000 or polyglycerol of molar mass up to 1000 g/mol.

The epoxy (meth)acrylates preferably have a number-average molar mass Mn of 200 to 20 000, more preferably of 200 to 10 000 g/mol, and very preferably of 250 to 3000 g/mol; the amount of (meth)acryloyl groups is preferably 1 to 5, more preferably 2 to 4, per 1000 g of epoxy (meth)acrylate or vinyl ether epoxide (determined by gel permeation chromatography using polystyrene as standard and tetrahydrofuran as eluent).

### Thiol-Functional Siloxane (B)

According to the invention, compound (B) has at least two mercapto groups, preferably two to 20, more preferably two to 15, more preferably two to twelve, particularly three to ten and especially four to six.

According to the invention, mercapto groups or thiol groups are understood to mean —SH groups, more preferably those bonded to tertiary carbon atoms, methine groups or methylene groups, more preferably those bonded to methylene groups.

Preferred compounds (B) have a number-average molecular weight Mₙ of at least 400 g/mol; in general, a molecular weight Mₙ of 5000 g/mol should not be exceeded, and it is preferably not more than 4500, more preferably not more than 4000, even more preferably not more than 3500 and especially not more than 3000 g/mol.

By virtue of the molecular weight specified, it is possible to keep the typical odor of the mercapto compounds as low as possible.

According to the invention, a siloxane is understood to mean a compound comprising at least one Si—O—Si bond. According to the invention, the siloxanes have at least three silicon atoms, preferably at least four and more preferably at least five.

The upper limit for the silicon atoms is restricted by the solubility of the siloxanes in the coating compositions and is preferably up to 30, more preferably up to 20 and most preferably up to 15. Compounds (B) of this kind are preferably obtainable by reaction of at least one ester of thiol-functional carboxylic acids with polyalcohols (B1) with a siloxane (B2) bearing at least as many, preferably exactly as many, vinyl groups as corresponds to the desired functionality of thiol groups. These vinyl groups are preferably bonded in the form of Si—CH═CH₂ moieties.

Compounds (B1) are esters of carboxylic acids bearing thiol groups with polyalcohols, these compounds having the required thiol group functionality.

Preference is given to compounds (B1a) of the formula

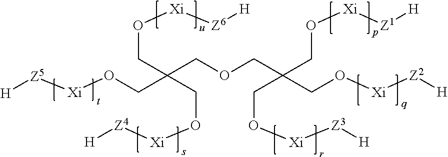

or compounds (B1b) of the formula

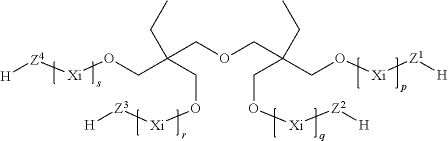

or compounds (B1c) of the formula

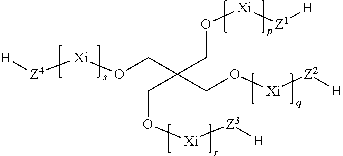

in which
Z¹, Z², Z³, Z⁴, Z⁵ and Z⁶ are each independently a single bond or a radical of the formula —(C═O)—R³—S—,
R³ is a divalent to C6-alkylene radical,
p, q, r, s, t, u are each independently zero or a positive integer from 1 to 5, preferably zero or a positive integer from 1 to 4 and more preferably zero or a positive integer from 1 to 3 and most preferably zero,
each Xᵢ for i=1 to p, 1 to q, 1 to r, 1 to s, 1 to t and 1 to u may independently be selected from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O—, preferably from the group of —CH₂—CH₂—O—, —CH₂—CH(CH₃)—O— and —CH(CH₃)—CH₂—O—, and more preferably —CH₂—CH₂—O—,
in which Ph is phenyl and Vin is vinyl,
with the proviso that, in the case of the compounds (B1a), at least four, preferably at least five and more preferably all six of the Z¹ to Z⁶ radicals are a group of the formula —(C═O)—R³—S—, and, in the case of the compounds (B1b) and (B1c), at least three, preferably all four, of the Z¹ to Z⁴ radicals are groups of the formula —(C═O)—R³—S—.

Examples of R³ are methylene, 1,2-ethylene, 1,2-propylene, 1,3-propylene, 1,4-butylene, 1,5-pentylene and 1,6-hexylene, preferably methylene, 1,2-ethylene, 1,3-propylene, 1,4-butylene and 1,5-pentylene, more preferably methylene and 1,2-ethylene.

In addition, the compounds (B1) may be difunctional or trifunctional compounds of the formula

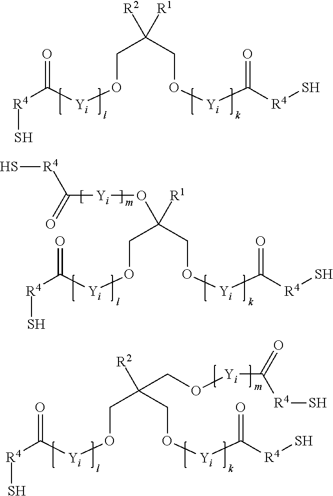

in which
R¹, R² are each independently hydrogen or a C₁- to C₄-alkyl radical,
R⁴ is methylene or 1,2-ethylene,
k, l, m, n are each independently zero or a positive integer from 1 to 5, preferably zero or a positive integer from 1 to 4 and more preferably zero or a positive integer from 1 to 3,
each Yᵢ for i=1 to k, 1 to l, 1 to m and 1 to n may independently be selected from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O—, preferably from the group of —CH₂—CH₂—O—, —CH₂—CH(CH₃)—O— and —CH(CH₃)—CH₂—O—, and more preferably —CH₂—CH₂—O—,
in which Ph is phenyl and Vin is vinyl.

Di- or trimercapto compounds (B1) are the esterification products of 3-mercaptopropionic acid or mercaptoacetic acid with diols or triols, the diols or triols being selected from the group consisting of ethylene glycol, propane-1,2-diol, propane-1,3-diol, 1,1-dimethylethane-1,2-diol, 2-butyl-2-ethylpropane-1,3-diol, 2-ethylpropane-1,3-diol, 2-methylpropane-1,3-diol, neopentyl glycol, butane-1,2-, -1,3- or -1,4-diol, hexane-1,6-diol, decane-1,10-diol, tetramethylcyclobutanediol, cyclohexane-1,2-, -1,3- or -1,4-diol, 2-ethylhexane-1,3-diol, 2,4-diethyloctane-1,3-diol, 2,2-bis(4-hydroxycyclohexyl)propane, cyclohexane-1,1-, -1,2-, -1,3- and -1,4-dimethanol, cyclohexane-1,2-, -1,3- or -1,4-diol, trimethylolbutane, trimethylolpropane, trimethylolethane, glycerol, and the alkoxylated, for example ethoxylated and/or propoxylated, preferably ethoxylated, products thereof.

Preferably, the di- or trifunctional compounds (B1) are esterification products of 3-mercaptopropionic acid or mercaptoacetic acid with polyethylene glycol of molar mass 106 to 2000, polypropylene glycol of molar mass 134 to 2500, polyTHF of molar mass 162 to 2000, optionally ethoxylated trimethylolpropane of molar mass 134 to 1500 and optionally ethoxylated glycerol of molar mass 92 to 1100.

More preferably, the di- or trifunctional compounds (B1) are

3-mercaptopropionic esters based on polypropylene glycol of molar mass 2200 (PPGMP 2200), 3-mercaptopropionic esters based on polypropylene glycol of molar mass 800 (PPGMP 800), ethoxylated trimethylpropane tri(3-mercaptopropionate) 1300 (ETTMP 1300), ethoxylated trimethylpropane tri(3-mercaptopropionate) 700 (ETTMP 700), trimethylolpropane trimercaptoacetates (TMPMA), glycol di(3-mercaptopropionate) (GDMP), trimethylolpropane tri(3-mercaptopropionate) (TMPMP).

Preferred compounds of this kind having two or three mercapto groups are selected from the group consisting of ethylene glycol di(3-mercaptopropionate) (GDMP), trimethylolpropane tri(3-mercaptopropionate) (TMPMP), trimethylolpropane trimercaptoacetate (TMPMA), 3-mercaptopropionic esters of poly-1,2-propylene glycol of molar mass 500 to 2500 g/mol or 3-mercaptopropionic esters of ethoxylated trimethylpropane of molar mass up to 1500 g/mol.

Examples of compounds (B1) having a higher functionality are pentaerythrityl tetra-(3-mercaptopropionate) (PETMP), pentaerythrityl tetramercaptoacetate (PETMA), dipentaerythrityl tetra(3-mercaptopropionate), dipentaerythrityl tetramercaptoacetate, dipentaerythrityl penta(3-mercaptopropionate), dipentaerythrityl pentamercaptoacetate, dipentaerythrityl hexa(3-mercaptopropionate), dipentaerythrityl hexamercaptoacetate, ditrimethylolpropane tetra(3-mercaptopropionate), ditrimethylolpropane tetramercaptoacetate, and the alkoxylated, for example ethoxylated and/or propoxylated, preferably ethoxylated, products thereof.

Preferred compounds (B1) are pentaerythrityl tetra(3-mercaptopropionate) (PETMP), pentaerythrityl tetramercaptoacetate (PETMA), dipentaerythrityl tetra(3-mercaptopropionate), dipentaerythrityl tetramercaptoacetate, dipentaerythrityl penta(3-mercaptopropionate), dipentaerythrityl pentamercaptoacetate, dipentaerythrityl hexa(3-mercaptopropionate), dipentaerythrityl hexamercaptoacetate, ditrimethylolpropane tetra(3-mercaptopropionate), ditrimethylolpropane tetramercaptoacetate, more preferably pentaerythrityl tetra(3-mercaptopropionate) (PETMP), pentaerythrityl tetramercaptoacetate (PETMA), dipentaerythrityl hexa(3-mercaptopropionate), dipentaerythrityl hexamercaptoacetate, ditrimethylolpropane tetra(3-mercaptopropionate), ditrimethylolpropane tetramercaptoacetate, and most preferably pentaerythrityl tetra-(3-mercaptopropionate) (PETMP) and pentaerythrityl tetramercaptoacetate (PETMA).

The vinyl-functional siloxanes (B2) are linear, vinyl-functional siloxanes of the formula (B2a)

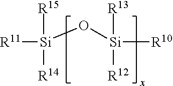

or cyclic vinyl-functional siloxanes of the formula (B2b)

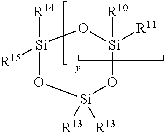

in which
the R¹⁰, R¹¹, R¹², R¹³, R¹⁴ and R¹⁵ radicals are each C₁- to C₄-alkyl or vinyl and
x is a positive integer from 2 to 9 and
y is a positive integer from 1 to 5,
with the proviso that at least two of the R¹⁰ to R¹⁵ radicals are vinyl, preferably two to six and more preferably two to four. Preferably, the R¹⁰ and R¹¹ radicals are each vinyl and the R¹² to R¹⁵ radicals are each C₁- to C₄-alkyl and particularly methyl.

Examples of C₁- to C₄-alkyl are methyl, ethyl, isopropyl, n-propyl, n-butyl, isobutyl, sec-butyl and tert-butyl, preferably methyl, ethyl and n-butyl, more preferably methyl and ethyl and most preferably methyl.

Preferred compounds (B2a) are tetravinylsilane, tetravinyldimethyldisiloxane, tetravinyl-1,3,5,7-tetramethylcyclotetrasilazane and hexavinyldisiloxane.

In a preferred embodiment, the compounds (B) are those of the formulae

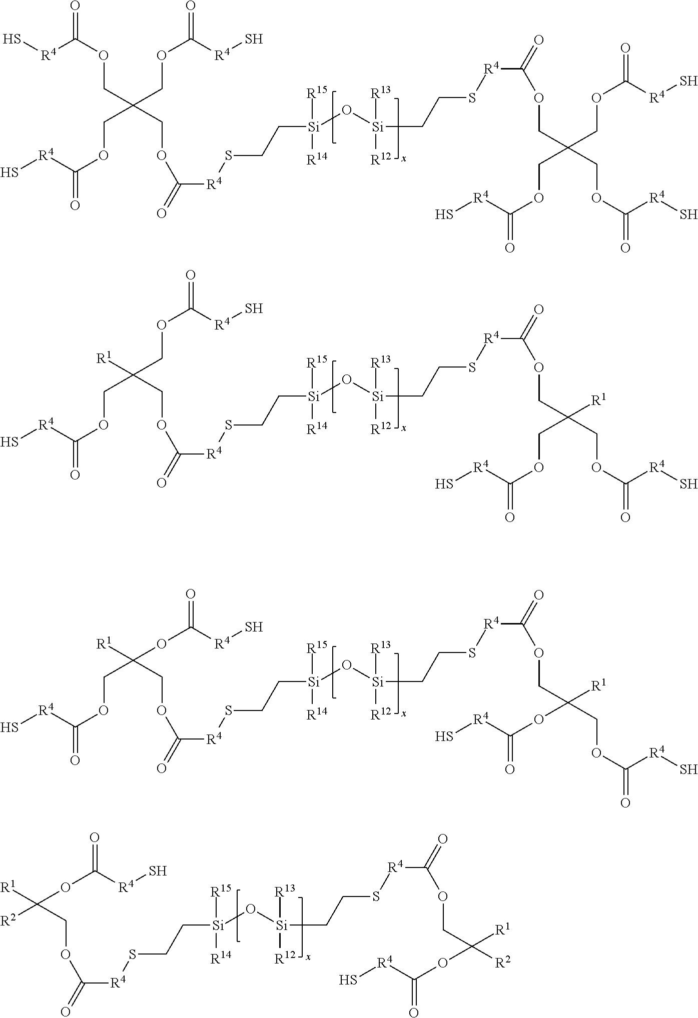

in which
R¹, R², R⁴, R¹², R¹³, R¹⁴, R¹⁵ and x are each as defined above.

Particular preference is given to compounds of the formula

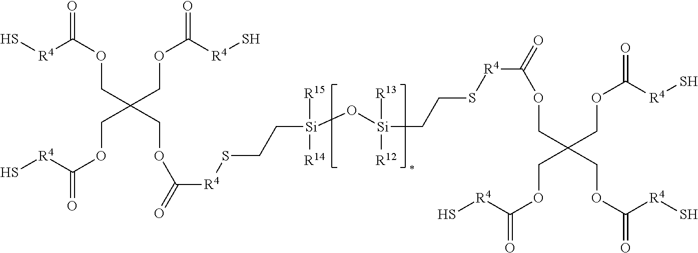

where R⁴=methylene or 1,2-ethylene, preferably 1,2-ethylene,
R¹², R¹³, R¹⁴, R¹⁵═C₁- to C₄-alkyl, preferably methyl, and
x=2 to 9, preferably 2 to 5.

The inventive coating compositions are preferably of the following composition:

(A) 20 to 95%, preferably 30 to 90%, by weight,
(B) 5 to 80%, preferably 10 to 70%, by weight,
(C) 0 to 10%, preferably 0.1-8%, by weight,
(D) 0 to 15%, preferably 0.01-10%, by weight,
(E) 0.01 to 10% by weight,
with the proviso that the sum always adds up to 100% by weight and the stoichiometry of thiol groups in (B) to (meth)acrylate groups in (A) is from 0.1:1 to 0.9:1, preferably 0.15:1 to 0.8:1.

In a preferred embodiment, the inventive coating compositions may be of the following composition:

(A) 60 to 95%, preferably 70 to 90%, by weight,
(B) 5 to 40%, preferably 10 to 30%, by weight,
(C) 0 to 10%, preferably 0.1-8%, by weight,
(D) 0 to 15%, preferably 0.01-10%, by weight,
(E) 0.01 to 10% by weight,
with the proviso that the sum always adds up to 100% by weight and the stoichiometry of thiol groups in (B) to (meth)acrylate groups in (A) is from 0.1:1 to 0.4:1, preferably 0.15:1 to 0.3:1.

In addition, the radiation-curable coating compositions may optionally comprise at least one photoinitiator and/or optionally further additives typical of coating materials.

Photoinitiators (C) may be, for example, photoinitiators known to the skilled worker, examples being those specified in “Advances in Polymer Science”, Volume 14, Springer Berlin 1974 or in K. K. Dietliker, Chemistry and Technology of UV and EB Formulation for Coatings, Inks and Paints, Volume 3; Photoinitiators for Free Radical and Cationic Polymerization, P. K. T. Oldring (Eds.), SITA Technology Ltd, London.

Possible options include, for example, mono- or bisacylphosphine oxides, as described, for example, in EP-A 7 508, EP-A 57 474, DE-A 196 18 720, EP-A 495 751 or EP-A 615 980, examples being 2,4,6-trimethylbenzoyldiphenylphosphine oxide (Lucirin® TPO from BASF AG), ethyl 2,4,6-trimethylbenzoylphenylphosphinate (Lucirin® TPO L from BASF AG), bis(2,4,6-trimethylbenzoyl)phenylphosphine oxide (Irgacure® 819 from Ciba Spezialitätenchemie), benzophenones, hydroxyacetophenones, phenylglyoxylic acid and its derivatives, or mixtures of these photoinitiators. Examples include benzophenone, acetophenone, acetonaphthoquinone, methyl ethyl ketone, valerophenone, hexanophenone, α-phenylbutyrophenone, p-morpholinopropiophenone, dibenzosuberone, 4-morpholinobenzophenone, 4-morpholinodeoxybenzoin, p-diacetylbenzene, 4-aminobenzophenone, 4′-methoxyacetophenone, β-methylanthraquinone, tert-butylanthraquinone, anthraquinonecarboxylic esters, benzaldehyde, α-tetralone, 9-acetylphenanthrene, 2-acetylphenanthrene, 10-thioxanthenone, 3-acetylphenanthrene, 3-acetylindole, 9-fluorenone, 1-indanone, 1,3,4-triacetylbenzene, thioxanthen-9-one, xanthen-9-one, 2,4-dimethylthioxanthone, 2,4-diethylthioxanthone, 2,4-di-iso-propylthioxanthone, 2,4-dichlorothioxanthone, benzoin, benzoin iso-butyl ether, chloroxanthenone, benzoin tetrahydropyranyl ether, benzoin methyl ether, benzoin ethyl ether, benzoin butyl ether, benzoin iso-propyl ether, 7H-benzoin methyl ether, benz[de]anthracen-7-one, 1-naphthaldehyde, 4,4′-bis(dimethylamino)benzophenone, 4-phenylbenzophenone, 4-chlorobenzophenone, Michler's ketone, 1-acetonaphthone, 2-acetonaphthone, 1-benzoylcyclohexan-1-ol, 2-hydroxy-2,2-dimethylacetophenone, 2,2-dimethoxy-2-phenylacetophenone, 2,2-diethoxy-2-phenylacetophenone, 1,1-dichloroacetophenone, 1-hydroxyacetophenone, acetophenone dimethyl ketal, o-methoxybenzophenone, triphenylphosphine, tri-o-tolylphosphine, benz[a]anthracene-7,12-dione, 2,2 diethoxyacetophenone, benzil ketals, such as benzil dimethyl ketal, 2-methyl-1-[4-(methylthio)phenyl]-2-morpholinopropan-1-one, anthraquinones such as 2-methylanthraquinone, 2-ethylanthraquinone, 2-tert-butylanthraquinone, 1-chloroanthraquinone, 2-amylanthraquinone and butane-2,3-dione.

Also suitable are nonyellowing or low-yellowing photoinitiators of the phenylglyoxalic ester type, as described in DE-A 198 26 712, DE-A 199 13 353 or WO 98/33761.

Preference among these photoinitiators is given to 2,4,6-trimethylbenzoyldiphenylphosphine oxide, ethyl 2,4,6-trimethylbenzoylphenylphosphinate, bis(2,4,6-trimethylbenzoyl)phenylphosphine oxide, benzophenone, 1-benzoylcyclohexan-1-ol, 2-hydroxy-2,2-dimethylacetophenone, and 2,2-dimethoxy-2-phenylacetophenone.

As further typical coatings additives it is possible for example to use antioxidants, stabilizers, activators (accelerants), fillers, pigments, dyes, antistats, flame retardants, thickeners, thixotropic agents, surface-active agents, viscosity modifiers, plasticizers or chelating agents.

It is additionally possible to add one or more thermally activatable initiators, for example potassium peroxodisulfate, dibenzoyl peroxide, cyclohexanone peroxide, di-tert-butyl peroxide, azobis-iso-butyronitrile, cyclohexylsulfonyl acetyl peroxide, di-iso-propyl percarbonate, tert-butyl peroctoate or benzpinacol, and, for example, those thermally activatable initiators which have a half-life of more than 100 hours at 80° C., such as di-tert-butyl peroxide, cumene hydroperoxide, dicumyl peroxide, tert-butyl perbenzoate, silylated pinacols, which are available commercially, for example, under the trade name ADDID 600 from Wacker, or hydroxyl-containing amine N-oxides, such as 2,2,6,6-tetramethylpiperidine N-oxyl, 4-hydroxy-2,2,6,6-tetramethylpiperidine N-oxyl, etc.

Other examples of suitable initiators are described in “Polymer Handbook”, 2nd ed., Wiley & Sons, New York.

Suitable thickeners include not only free-radically (co)polymerized (co)polymers but also customary organic and inorganic thickeners such as hydroxymethylcellulose or bentonite.

As chelating agents it is possible, for example, to use ethylenediamineacetic acid and its salts, and also β-diketones.

Suitable fillers comprise silicates, for example silicates obtainable by hydrolysis of silicon tetrachloride, such as Aerosil® from Degussa, siliceous earth, talc, aluminum silicates, magnesium silicates, and calcium carbonates, etc.

Suitable stabilizers comprise typical UV absorbers such as oxanilides, triazines and benzotriazole (the latter obtainable as Tinuvin® products from Ciba-Spezialitätenchemie), and benzophenones. They can be used alone or together with suitable free-radical scavengers, examples being sterically hindered amines such as 2,2,6,6-tetramethylpiperidine, 2,6-di-tert-butylpiperidine or derivatives thereof, for example bis(2,2,6,6-tetramethyl-4-piperidyl) sebacate. Stabilizers are typically used in amounts of 0.1 to 5.0% by weight, based on the solid components present in the preparation.

Compounds (E) are aromatic compounds having at least two hydroxyl groups bonded to the aromatic ring, preferably to the benzene or naphthalene ring.

Examples thereof are given in WO 2012/126695, page 14 therein.

Preference is given to optionally alkylated dihydroxybenzenes, optionally alkylated trihydroxybenzenes and pyrogallol. Particular preference is given to pyrogallol, 4-tert-butyl-1,2-dihydroxybenzene and hydroquinone.

Compound (D) functions as a stabilizer for the mixture, as known from WO 2012/126695, and is selected from the group consisting of phosphonic acids, phosphoric acids, phosphorous esters and triarylphosphines.

Examples of phosphonic acids are free phosphonic acid (HP(O)(OH)₂), and aryl- and alkylphosphonic acids (RP(O)(OH)₂), where the alkyl radical is a C₁- to C₁₀-alkyl radical and the aryl radical is a C₆- to C₁₂-aryl radical.

Examples of C₆- to C₁₂-aryl radicals are phenyl, benzyl, o-, m- or p-tolyl, xylyl and naphthyl. Further examples are known from WO 2012/126695; see page 13 last paragraph therein.

Examples of phosphoric acids are orthophosphoric acid (H₃PO₄) and polyphosphoric acids (Hₙ₊₂PₙO₃ₙ₊₁).

Examples of phosphorous esters are tri-C₁-bis C₁₀-alkyl or tri-C₆-bis C₁₂-aryl phosphites, preferably trimethyl phosphite, triethyl phosphite, tri-n-butyl phosphite and triphenyl phosphite.

Examples of triarylphosphines are tri-C₁-bis C₁₀-alkyl- or tri-C₆-bis C₁₂-arylphosphines, preferably trimethylphosphine, triethylphosphine, tri-n-butylphosphine, trihexylphosphine and triphenylphosphine.

The coating compositions of the invention can be used to coat a variety of substrates, such as wood, wood veneer, paper, paperboard, cardboard, textile, leather, nonwoven, plastics surfaces, glass, ceramic, mineral building materials, and coated or uncoated metals.

It is possible to use coating compositions of this kind especially in primers, surfacers, pigmented topcoat materials and clearcoat materials in the sectors of automotive refinish and finishing of large vehicles. Coating materials of this kind are particularly suitable for applications requiring a particularly high level of reliability in application, external weathering resistance, optical qualities, resistance to solvents, chemicals, and water, as in automotive refinish and the finishing of large vehicles.

The coating compositions of the invention are suitable for coating of substrates such as wood, paper, textile, leather, nonwoven, plastic surfaces, glass, ceramic, mineral building materials, such as cement moldings and fiber-cement slabs, or coated or uncoated metals, preferably plastics or metals, particularly in the form of thin sheets, and with particular preference metals.

The coating compositions of the invention are suitable as or in exterior coatings, in other words in those applications involving exposure to daylight, preferably parts of buildings, interior coatings, and coatings on vehicles and aircraft. In particular, the coating compositions of the invention are used as or in automotive clearcoat and topcoat material(s). Further preferred fields of use are can coating and coil coating.

In particular, they are suitable as primers, surfacers, pigmented topcoat materials, and clearcoat materials in the sectors of industrial coating, wood coating, automotive finishing, especially OEM finishing, or decorative coating. The coating materials are especially suitable for applications requiring a particularly high level of reliability in application, outdoor weathering resistance, optical qualities, scratch resistance, solvent resistance and/or chemical resistance.

Coating of the substrates with the coating compositions of the invention takes place in accordance with customary methods which are known to the skilled worker and involve applying a coating composition of the invention, or a coating formulation comprising it, to the substrate to be coated in the desired thickness, and optionally drying it. This operation may be repeated once or more than once if desired. Application to the substrate may take place in a known way, such as for example by spraying, troweling, knifecoating, brushing, rolling, roller coating, pouring, laminating, injection-backmolding or coextruding.

The coating thickness is generally in a range from about 3 to 1000 g/m² and preferably 10 to 200 g/m².

Additionally disclosed is a method of coating substrates which involves adding, optionally, further, typical coatings additives and thermally curable, chemically curable or radiation-curable resins to a coating composition of the invention or to a coating formulation comprising it, applying the resulting formulation to the substrate, optionally drying it, and curing it with electron beams or by UV exposure under inert gas or preferably under an oxygen-containing atmosphere, optionally with thermal treatment at temperatures up to the level of the drying temperature, and subsequently at temperatures up to 160° C., preferably between 60 and 160° C., more preferably between 100 and 160° C.

Radiation curing takes place with high-energy light, UV light for example, or electron beams. Radiation curing may take place at relatively high temperatures. Preference is given in this case to a temperature above the T_{g} of the radiation-curable binder.

The coating materials may be applied one or more times by a very wide variety of spraying methods, such as compressed-air, airless or electrostatic spraying methods, using one- or two-component spraying units, or else by injecting, troweling, knifecoating, brushing, rolling, roller coating, pouring, laminating, injection-backmolding or coextruding.

Drying and curing of the coatings takes place in general under standard temperature conditions, i.e., without the coating being heated. Alternatively, the mixtures of the invention can be used to produce coatings which, following application, are dried at an elevated temperature, for example at 40-250° C., preferably 40-150° C., and in particular at 40 to 100° C., and cured with radiation. This is limited by the thermal stability of the substrate.

Additionally disclosed is a method of coating substrates which involves adding, optionally, thermally curable resins to the coating composition of the invention or coating formulations comprising it, applying the resulting formulation to the substrate, drying it, and then curing it with electron beams or UV exposure under inert gas or, preferably, with radiation under an oxygen-containing atmosphere, optionally at temperatures up to the level of the drying temperature.

The method of coating substrates can also be practiced by irradiating the applied coating composition of the invention or coating formulations of the invention first with electron beams or by UV exposure under oxygen or, preferably, under inert gas, in order to obtain preliminary curing, then carrying out thermal treatment at temperatures up to 160° C., preferably between 60 and 160° C., and subsequently completing curing with electron beams or by UV exposure under inert gas or, preferably, under oxygen with radiation.

Optionally, if a plurality of layers of the coating material are applied one on top of another, drying and/or radiation curing may take place after each coating operation.

Examples of suitable radiation sources for the radiation cure are low-pressure mercury lamps, medium-pressure mercury lamps with high-pressure lamps, and fluorescent tubes, pulsed lamps, metal halide lamps, electronic flash units, with the result that radiation curing is possible without a photoinitiator, or excimer lamps. The radiation cure is accomplished by exposure to high-energy radiation, i.e., UV radiation, or daylight, preferably light in the wavelength range of λ=200 to 700 nm, more preferably λ=200 to 500 nm, and very preferably λ=250 to 400 nm, or by exposure to high-energy electrons (electron beams; 150 to 300 keV). Examples of radiation sources used include high-pressure mercury vapor lamps, lasers, pulsed lamps (flash light), LED lamps, halogen lamps or excimer lamps. The radiation dose normally sufficient for crosslinking in the case of UV curing is in the range from 80 to 3000 mJ/cm².

It will be appreciated that a number of radiation sources can also be used for the cure, for example two to four.

These sources may also emit each in different wavelength ranges.

Drying and/or thermal treatment may also take place, in addition to or instead of the thermal treatment, by means of NIR radiation, which here refers to electromagnetic radiation in the wavelength range from 760 nm to 2.5 μm, preferably from 900 to 1500 nm.

Irradiation can optionally also be carried out in the absence of oxygen, for example under an inert gas atmosphere. Suitable inert gases are preferably nitrogen, noble gases, carbon dioxide, or combustion gases. In addition, irradiation can be effected by covering the coating composition with transparent media. Transparent media are, for example, polymeric films, glass or liquids, e.g., water. Particular preference is given to irradiation in the manner as described in DE-A1 199 57 900.

It is an advantage of the coating compositions of the invention that they also result, when cured under an oxygenous atmosphere, in coating properties of a similar standard to those in the case of curing under an inert atmosphere.

ppm and percentage figures used in this specification are by weight unless otherwise indicated.

The examples below are intended to illustrate the invention but not to limit it to these examples.

### EXAMPLES

### Example 1

A mixture of 0.1 part AlBN, 18.4 parts toluene, 10.6 parts pentaerythrityl tetrakis-3-mercaptopropionate and 2.6 parts divinylhexamethyltrisiloxane was stirred under nitrogen at 80° C. for 6 h. Subsequently, the volatile constituents were removed by means of vacuum distillation. The reaction product, which was of moderate viscosity and had a content of dimethylsiloxane units (calculated as —Si(CH₃)₂—O—) of 19.5%, was colorless and clear and was used without further workup.

### Example 2

A mixture of 0.1 part AIBN, 13.5 parts toluene, 11.3 parts pentaerythrityl tetrakis-3-mercaptopropionate and 2.1 parts divinyloctamethyltetrasiloxane was stirred under nitrogen at 80° C. for 6 h. Subsequently, the volatile constituents were removed by means of vacuum distillation. The reaction product, which was of moderate viscosity and had a content of dimethylsiloxane units (calculated as —Si(CH₃)₂—O—) of 16.0%, was colorless and clear and was used without further workup.

### Example 3

A mixture of 0.1 part AIBN, 17.6 parts toluene, 10.1 parts pentaerythrityl tetrakis-3-mercaptopropionate and 2.5 parts divinylpolydimethyloligosiloxane (n˜4) was stirred under nitrogen at 80° C. for 6 h. Subsequently, the volatile constituents were removed by means of vacuum distillation. The reaction product, which was of moderate viscosity and had a content of dimethylsiloxane units (calculated as —Si(CH₃)₂—O—) of 20.0%, was colorless and clear and was used without further workup.

### Example 4

A mixture of 0.1 part AIBN, 22.3 parts toluene, 10.4 parts pentaerythrityl tetrakis-3-mercaptopropionate and 4.2 parts divinylpolydimethyloligosiloxane (n˜8) was stirred under nitrogen at 80° C. for 6 h. Subsequently, the volatile constituents were removed by means of vacuum distillation. The reaction product, which was of moderate viscosity and had a content of dimethylsiloxane units (calculated as —Si(CH₃)₂—O—) of 28.5%, was colorless and clear and was used without further workup.

### Comparative Example 1

A mixture of 0.1 part AIBN, 12.8 parts toluene, 11.1 parts pentaerythrityl tetrakis-3-mercaptopropionate and 1.1 parts 1,3-divinyltetramethyldisiloxane was stirred under nitrogen at 80° C. for 6 h. Subsequently, the volatile constituents were removed by means of vacuum distillation. The reaction product, which was of moderate viscosity and had a content of dimethylsiloxane units (calculated as —Si(CH₃)₂—O—) of 8.7%, was colorless and clear and was used without further workup.

### Example 5

### Determination of the Surface Activity of the Thiols

3 parts in each case of the surface-active thiols from the examples were dissolved in an 97 parts of a commercially available urethane acrylate (Laromer® LR 8987 from BASF, Ludwigshafen), and 1.5% of the photoinitiator Irgacure® 500 (BASF SE, mixture of 50% by weight of 1-hydroxycyclohexyl phenyl ketone and 50% by weight of benzophenone) was added. Application by bar coating with an 80 μm bar coater was followed by equilibration at room temperature for 1 hour, and then by exposure on an IST UV exposure system at 1400 mJ/cm². The desired enrichment of the thiols at the surface had to be detected by suitable analysis methods. A surface-sensitive method that combines very high depth resolution in the region of a few nanometres combined with high detection strength and chemical selectivity is time-of-flight secondary ion mass spectrometry (ToF-SIMS). This involves firing a primary ion beam (bismuth cluster ions Bi₃+, energy 25 keV) at the sample and detecting the charged secondary ions formed (atomic ions, molecular fragments and/or intact molecular ions). These ions originate only from the first atom layers of the sample, which gives rise to the high surface sensitivity. Since it is possible in this way to analyze only the surface, and not the material beneath, organic materials can be stripped away with singly charged argon gas clusters (cluster distribution centred at Ar₁₅₀₀+, projectile energy 20 keV) without destruction of the chemical information. In this way, secondary ion mass spectra are obtained as a function of depth. Being an MS method, SIMS is not directly quantifiable because of the matrix dependence of the ionization. In a uniform matrix, however, there is virtually no change in the ionization probability of additives, and so the relative signal distribution reflects the true amounts of additive.

The enrichment becomes quantifiable when the amount of thiol at a certain depth is calculated as the sum of all thiol-relevant secondary ion species (S⁻, and SO₃⁻ oxidized by air curing). The intensity of the SO₃⁻ has to be corrected using the sensitivity factor for the acrylate matrix present, i.e. the relatively less probable formation of the S⁻ secondary ion compared to SO₃⁻. This factor can be determined to be 0.15 from the profile of the non-migrating pentaerythrityl tetra(3-mercaptopropionate) (PETMP) sample as a comparison. Thus, the enrichment factor of the thiol is calculated as T (surface area)/T (volume, d>1 μm), as follows:

| Thiol | Enrichment factor |
|---|---|
| PETMP | 1 |
| Comparative example 1 | 1.25 |
| Example 1 | 2.1 |
| Example 2 | 2.4 |
| Example 3 | 2.4 |
| Example 4 | 3.1 |

The absence of surface enrichment of pentaerythrityl tetra(3-mercaptopropionate) (PETMP) and the sample from the comparative example is apparent, as is a distinct enrichment by a factor of more than 2 for the samples according to examples 1 to 4.

1. A coating composition comprising:
(A) at least one multifunctional (meth)acrylate having at least two (meth)acrylate groups,
(B) at least one siloxane having at least three silicon atoms, and having at least two thiol groups,
(C) optionally at least one photoinitiator,
(D) optionally at least one compound selected from the group consisting of phosphonic acids, phosphoric acids, phosphorous esters and triarylphosphines,
(E) at least one aromatic compound having at least two hydroxyl groups bonded to the aromatic ring.

2. The coating composition according to claim 1, wherein compound (A) is selected from the group consisting of (A1a) (meth)acrylates of polyols having the corresponding functionality, (A1b) urethane (meth)acrylates, (A1c) polyester (meth)acrylates, (A1d) polyether (meth)acrylates and (A1e) epoxy (meth)acrylates.

3. The coating composition according to claim 2, wherein compound (A1a) is selected from the group consisting of fully (meth)acrylated or at least tetra(meth)acrylated (meth)acrylic esters of pentaerythritol, ditrimethylolpropane, dipentaerythritol, sorbitol, mannitol, diglycerol, threitol, erythritol, adonitol (ribitol), arabitol (lyxitol), xylitol, dulcitol (galactitol), maltitol and isomalt, and the up to decaethoxylated and/or -propoxylated (per hydroxyl group) products thereof.

4. The coating composition according to claim 1, wherein compound (B) is obtainable by reaction of at least one ester of thiol-functional carboxylic acids with polyalcohols (B1) with a siloxane (B2) bearing at least as many vinyl groups as corresponds to the desired functionality of thiol groups.

5. The coating composition according to claim 4, wherein the compounds (B1) are compounds (B1a) of the formula 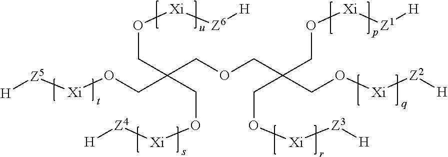
or compounds (B1b) of the formula 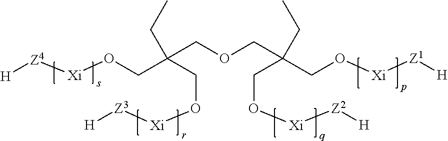
or compounds (B1c) of the formula 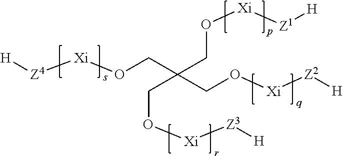
in which
Z¹, Z², Z³, Z⁴, Z⁵ and Z⁶ are each independently a single bond or a radical of the formula —(C═O)—R³—S—,
R³ is a divalent C₁- to C₆-alkylene radical,
p, q, r, s, t, u are each independently zero or a positive integer from 1 to 5,
each Xᵢ for i=1 to p, 1 to q, 1 to r, 1 to s, 1 to t and 1 to u may independently be selected from the group consisting of —CH₂—CH₂—O—, —CH₂—CH(CH₃)—O—, —CH(CH₃)—CH₂—C(CH₃)₂—O—, —C(CH₃)₂—CH₂—O—, —CH₂-Vin-O—, —CHVin-CH₂—O—, —CH₂—CHPh-O— and —CHPh-CH₂—O
in which Ph is phenyl and Vin is vinyl,
with the proviso that, in the case of the compounds (B1a), at least four of the Z¹ to Z⁶ radicals are a group of the formula —(C═O)—R³—S—, and, in the case of the compounds (B1b) and (B1c), at least three of the Z¹ to Z⁴ radicals are groups of the formula —(C═O)—R³—S—.

6. The coating composition according to claim 4, wherein the compounds (B1) are pentaerythrityl tetra-(3-mercaptopropionate) (PETMP), pentaerythrityl tetramercaptoacetate (PETMA), dipentaerythrityl tetra(3-mercaptopropionate), dipentaerythrityl tetramercaptoacetate, dipentaerythrityl penta(3-mercaptopropionate), dipentaerythrityl pentamercaptoacetate, dipentaerythrityl hexa(3-mercaptopropionate), dipentaerythrityl hexamercaptoacetate, ditrimethylolpropane tetra(3-mercaptopropionate), ditrimethylolpropane tetramercaptoacetate, and the alkoxylated, for example ethoxylated and/or propoxylated, products thereof.

7. The coating composition according to claim 4, wherein the compounds (B1) are difunctional or trifunctional compounds of the formula 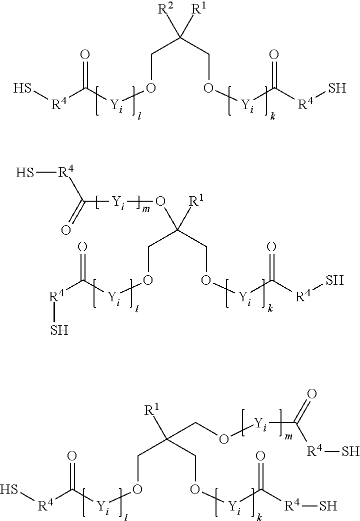
in which
R¹, R² are each independently hydrogen or a C₁- to C₄-alkyl radical,
R⁴ is methylene or 1,2-ethylene,
k, l, m, n are each independently zero or a positive integer from 1 to 5,
each Yᵢ for i=1 to k, 1 to l, 1 to m and 1 to n may independently be selected from the group consisting of —CH₂—CH₂—O—, —CH₂—CH(CH₃)—O—, —CH(CH₃)—CH₂—O—, —CH₂—C(CH₃)₂—O—, —C(CH₃)₂—CH₂—O—, —CH₂—CHVin-O—, —CHVin-CH₂—O—, —CH₂—CHPh-O— and —CHPh-CH₂—O,
in which Ph is phenyl and Vin is vinyl.

8. The coating composition according to claim 4, wherein the compounds (B1) are 3-mercaptopropionic esters based on polypropylene glycol of molar mass 2200 (PPGMP 2200), 3-mercaptopropionic esters based on polypropylene glycol of molar mass 800 (PPGMP 800), ethoxylated trimethylpropane tri(3-mercaptopropionate) 1300 (ETTMP 1300), ethoxylated trimethylpropane tri(3-mercaptopropionate) 700 (ETTMP 700), trimethylolpropane trimercaptoacetates (TMPMA), glycol di(3-mercaptopropionate) (GDMP), or trimethylolpropane tri(3-mercaptopropionate) (TMPMP).

9. The coating composition according to claim 4, wherein the vinyl-functional siloxanes (B2) are linear, vinyl-functional siloxanes of the formula (B2a) 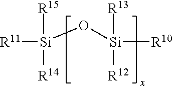
or cyclic vinyl-functional siloxanes of the formula (B2b) 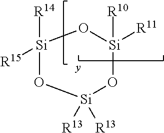
in which
the R¹⁰, R¹¹, R¹², R¹³, R¹⁴ and R¹⁵ radicals are each C₁- to C₄-alkyl or vinyl and
x is a positive integer from 2 to 9 and
y is a positive integer from 1 to 5,
with the proviso that at least two of the R¹⁰ to R¹⁵ radicals are vinyl.

10. The coating composition according to claim 4, wherein the vinyl-functional siloxane (B2) is selected from the group consisting of tetravinylsilane, tetravinyldimethyldisiloxane, tetravinyl-1,3,5,7-tetramethylcyclotetrasilazane and hexavinyldisiloxane.

11. The coating composition according to claim 1, wherein the compounds (B) are those of the formulae 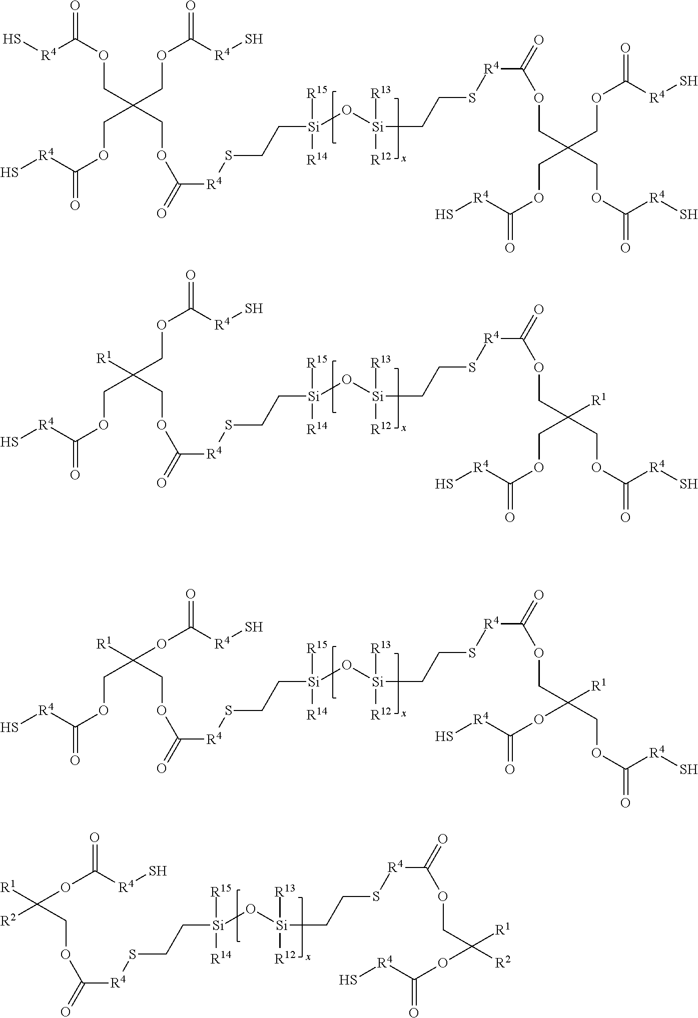
in which
R¹, R² are each independently hydrogen or a C₁- to C₄-alkyl radical,
R⁴ is methylene or 1,2-ethylene, and
R¹², R¹³, R¹⁴ and R¹⁵ radicals are each C₁- to C₄-alkyl or vinyl.

12. The coating composition according to claim 1, of the following composition:
(A) 20 to 95% by weight,
(B) 5 to 80% by weight,
(C) 0 to 10% by weight,
(D) 0 to 15% by weight,
(E) 0.01 to 10% by weight,
with the proviso that the sum always adds up to 100% by weight and the stoichiometry of thiol groups in (B) to (meth)acrylate groups in (A) ranges from 0.1:1 to 0.9:1.

13. The coating composition according to claim 1, of the following composition:
(A) 60 to 95%, by weight,
(B) 5 to 40%, by weight,
(C) 0 to 10%,
(D) 0 to 15%,
(E) 0.01 to 10% by weight,
with the proviso that the sum always adds up to 100% by weight and the stoichiometry of thiol groups in (B) to (meth)acrylate groups in (A) ranges from 0.1:1 to 0.4:1.

14. A process for coating at least one substrate(s), which comprises applying a coating composition according to claim 1 to a substrate.

15. The process of claim 14, further comprising applying the substrate in a predetermined thickness to the substrate and drying.

16. The process of claim 14, further comprising drying and/or curing the coating composition applied to the substrate.

17. The coating composition according to claim 12, wherein
(A) ranges from 30 to 90% by weight,
(B) ranges from 10 to 70% by weight,
(C) ranges from 0.1 to 8% by weight,
(D) ranges from 0.01 to 10% by weight, and
(E) ranges from 0.01 to 10% by weight.

18. The coating composition according to claim 12, wherein the stoichiometry of thiol groups in (B) to (meth)acrylate groups in (A) ranges from 0.15:1 to 0.8:1.

19. The coating composition according to claim 13, wherein
(A) ranges from 70 to 90% by weight,
(B) ranges from 10 to 30% by weight,
(C) ranges from 0.1 to 8% by weight,
(D) ranges from 0.1 to 10% by weight, and
(E) ranges from 0.01 to 10% by weight.

20. The coating composition according to claim 13, wherein the stoichiometry of thiol groups in (B) to (meth)acrylate groups in (A) ranges from 0.15:1 to 0.3:1.
